(19) United States
(12) Patent Application Publication
(10) Pub. No.: US 2026/0133432 A1
(43) Pub. Date: May 14, 2026

(54) Integrated Short Wave Optical Module And Its Fabrication Method

(71) Applicant: Fuzhou Photop Optics Co., Ltd., Fujian Province (CN)

(72) Inventors: Xu Jia, Fuzhou (CN); Junjie Chen, Fuzhou (CN); Shunmin Cheng, Fuzhou (CN); Hengyi Fu, Fuzhou (CN); Jesse Zheng, Fuzhou (CN); Yan Jiang, Fuzhou (CN); Guanglong Yu, Fuzhou (CN); Lei Lin, Fuzhou (CN)

(21) Appl. No.: 19/006,579

(22) Filed: Dec. 31, 2024

(30) Foreign Application Priority Data
Nov. 8, 2024 (CN) 2024115995586

(51) Int. Cl. G02B 27/30; G02B 27/10; G02B 27/12

(52) U.S. Cl. CPC G02B 27/30; G02B 27/1006; G02B 27/126

(57) ABSTRACT

Embodiments of the present disclosure comprise a shortwave optical module, comprising a glass platform with one or more glass spacers, a light collimation module, a glass light reflection module, and one or more glass lens arrays mounted.

### TECHNICAL FIELD

The present disclosure generally relates to an integrated short wave optical module and its fabrication method.

### BACKGROUND

Aspects of the present disclosure relate to an integrated short wave optical module and its fabrication method. In this regard, conventional short wave optical modules may be costly, cumbersome, and/or inefficient.

Limitations and disadvantages of conventional systems and methods will become apparent to one of skill in the art, through comparison of such approaches with some aspects of the present methods and systems set forth in the remainder of this disclosure with reference to the drawings.

### BRIEF SUMMARY OF THE DISCLOSURE

Shown in and/or described in connection with at least one of the figures, and set forth more completely in the claims is an integrated short wave optical module and its fabrication method.

These and other advantages, aspects and novel features of the present disclosure, as well as details of illustrated embodiments thereof, will be more fully understood from the following description and drawings.

### BRIEF DESCRIPTION OF THE DRAWINGS

The various features and advantages of the present disclosure may be more readily understood with reference to the following detailed description taken in conjunction with the accompanying drawings, wherein like reference numerals designate like structural elements.

FIG. 1 is an exemplary shortwave module 1 in accordance with the present disclosure.

FIG. 1A illustrates an exemplary function of an emission light path, in accordance with the structure illustrated in FIG. 1.

FIG. 1B illustrates an exemplary function of a reception light path, in accordance with the structure illustrated in FIG. 1.

FIG. 1C illustrates an exemplary function of a plurality of emission paths, in accordance with various embodiments of the disclosure.

FIG. 1D illustrates an exemplary embodiment of the short-wave module according to various embodiments of the disclosure.

FIG. 1E illustrates an exemplary embodiment of the short-wave module according to various embodiments of the disclosure comprising a plurality of rhombic prisms.

FIG. 2 illustrates an exemplary embodiment of the short-wave module according to various embodiments of the disclosure comprising a splitting prism

FIG. 2A illustrates the function of the embodiment shown in FIG. 2.

FIG. 3 illustrates an exemplary embodiment according to the disclosure further comprising a light shrinking module 70.

FIG. 3A illustrates the function of the shortwave module according to the embodiment of FIG. 3.

FIG. 4 illustrates an exemplary embodiment according to the disclosure, further comprising a light deflection prism 80.

FIG. 4A illustrates a partial top view of the embodiment shown in FIG. 4.

FIG. 4B illustrates the function of the exemplary embodiment shown in FIG. 4.

FIG. 4C is a partial top view of FIG. 4, illustrating the lateral deflection effect of the deflection prism 80 on the light.

FIG. 5 illustrates an exemplary shortwave optical module, in accordance with various embodiments of the disclosure.

FIG. 5A illustrates the function of the exemplary embodiment of FIG. 5.

FIG. 6 illustrates a shortwave optical module in accordance with various embodiments of the disclosure, further comprising a trapezoidal light reflection module 40.

FIG. 6A illustrates the operation of an embodiment of the disclosure according to FIG. 6.

### DETAILED DESCRIPTION

The following discussion provides various examples of an integrated short wave optical module and its fabrication method. Such examples are non-limiting, and the scope of the appended claims should not be limited to the particular examples disclosed. In the following discussion, the terms “example” and “e.g.,” are non-limiting.

The figures illustrate the general manner of construction, and descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “or” means any one or more of the items in the list joined by “or”. As an example, “x or y” means any element of the three-element set {(x), (y), (x, y)}. As another example, “x, y, or z” means any element of the seven-element set {(x), (y), (z), (x, y), (x, z), (y, z), (x, y, z)}.

The terms “comprises,” “comprising,” “comprises,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

In recent years, with the rapid development and popularization of 5G communication, Internet of things, cloud computing, big data, new generation AI and other technology applications, the demand for network capacity has increased exponentially, which not only promoted the market demand for optical transceiver modules (optical module for short), but also sped up the iterative upgrading of optical modules. Higher speed, lower power consumption and small integration are the development trend of optical modules, and also the continuous demand of cloud manufacturers in the construction of large data centers.

Often, short wave optical modules comprise plastic components, made by injection molding process, and the typical material used in the injection molding process may be PEI (Polyetherimide). PEI is an amorphous high-performance polymer, which is an engineering plastic made of amorphous PEI and may be extruded at high temperatures. Although plastic components can directly form an integrated structure through the injection molding process, the injection molding process may sometimes not achieve high-precision in size and surface shape. The plastic material may have the disadvantages of a large thermal expansion coefficient, large absorption of optical signals, among others.

Embodiments of the present disclosure may comprise a shortwave optical module, the module comprising a glass platform. Embodiments may also comprise one or more glass spacers. Embodiments may also comprise a light collimation module. Embodiments may also comprise a glass light reflection module. Embodiments may also comprise one or more glass lens arrays.

In some embodiments, the glass may comprise monocrystalline silicon, fused silica, fused quartz, polymer glass, or a glass-like transparent material with a refractive index similar to glass. In some embodiments, the one or more glass spacers may be made of the same material as at least one of the one or more lens arrays. In some embodiments, the light collimating module may comprise an optical fiber array, a lens array, a spacer, and an optional air gap.

In some embodiments, the light collimation module may comprise a light splitting module, a light shrinking module, or a light deflection module. In some embodiments, the light splitting module may comprise a Z-block. In some embodiments, the light shrinking module may comprise a plurality of wedge modules and/or curved lenses.

In some embodiments, the light deflection module may comprise an oblique parallelogram prism. In some embodiments, the one or more glass lens arrays may comprise a plurality of lenses. In some embodiments, the one or more glass lens arrays may be made using high-precision cold processing, a polymer on glass imprinting process, a molding process, an embossing process, or an etching process.

In some embodiments, the glass light reflection module may comprise one or more rhombic prisms, a right-angle prism, a diamond-shaped prism, or a trapezoidal prism. In some embodiments, the glass light reflection module may comprise one or more anti-reflective coatings. In some embodiments, the shortwave optical module may comprise a splitting prism, operable to physically separate an incident light into a plurality of signals of different wavelengths.

In some embodiments, the shortwave optical module may comprise a light deflection module operable to vertically align a plurality of light beams at the output of the light deflection module. In some embodiments, the shortwave optical module may comprise a trapezoidal prism operable as beam splitter for an incident light beam.

Embodiments of the present disclosure may also comprise a method of fabricating a shortwave optical module, the method comprising providing a glass platform. Embodiments may also comprise coupling one or more glass spacers to the glass platform. Embodiments may also comprise coupling a light collimation module to the glass platform. Embodiments may also comprise coupling a glass light reflection module to the glass platform. Embodiments may also comprise generating on the glass platform one or more glass lens arrays, or coupling to the glass platform one or more glass lens arrays.

In some embodiments, the method may comprise using monocrystalline silicon, fused silica, fused quartz, polymer glass, or a glass-like transparent material with a refractive index similar to glass for the glass. In some embodiments, the method may comprise making the one or more glass spacers from the same material as at least one of the one or more lens arrays.

In some embodiments, the method may comprise forming the light collimating module from an optical fiber array, a lens array, a spacer, and an optional air gap. In some embodiments, the method may comprise forming the light collimation module from a light splitting module, a light shrinking module, and/or a light deflection module.

In some embodiments, the method may comprise employing a Z-block in the light splitting module. In some embodiments, the method may comprise employing a plurality of wedge modules and/or curved lenses in the light shrinking module. In some embodiments, the method may comprise employing an oblique parallelogram prism in the light deflection module.

In some embodiments, the method may comprise employing a plurality of lenses in the one or more glass lens arrays. In some embodiments, the method may comprise generating the one or more glass lens arrays by high-precision cold processing, a polymer on glass imprinting process, a molding process, an embossing process, or an etching process.

In some embodiments, the method may comprise employing one or more rhombic prisms, a right-angle prism, a diamond-shaped prism, or a trapezoidal prism in the glass light reflection module. In some embodiments, the method may comprise employing one or more anti-reflective coatings in the glass light reflection module.

In some embodiments, the method may comprise employing a splitting prism operable to physically separate an incident light into a plurality of signals of different wavelengths in the shortwave optical module. In some embodiments, the method may comprise employing a light deflection module operable to vertically align a plurality of light beams at the output of the light deflection module in the shortwave optical module. In some embodiments, the method may comprise employing a trapezoidal prism operable as beam splitter for an incident light beam in the shortwave optical module.

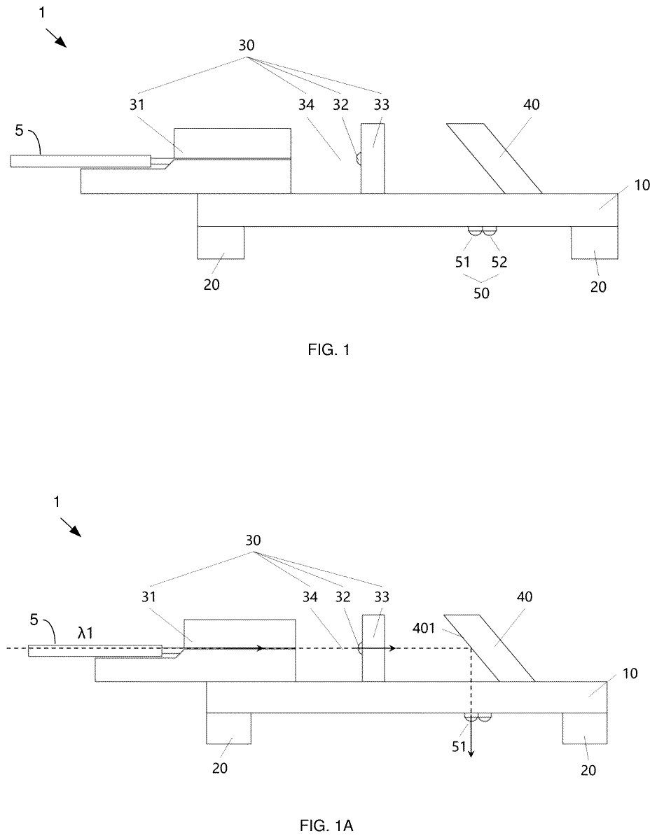

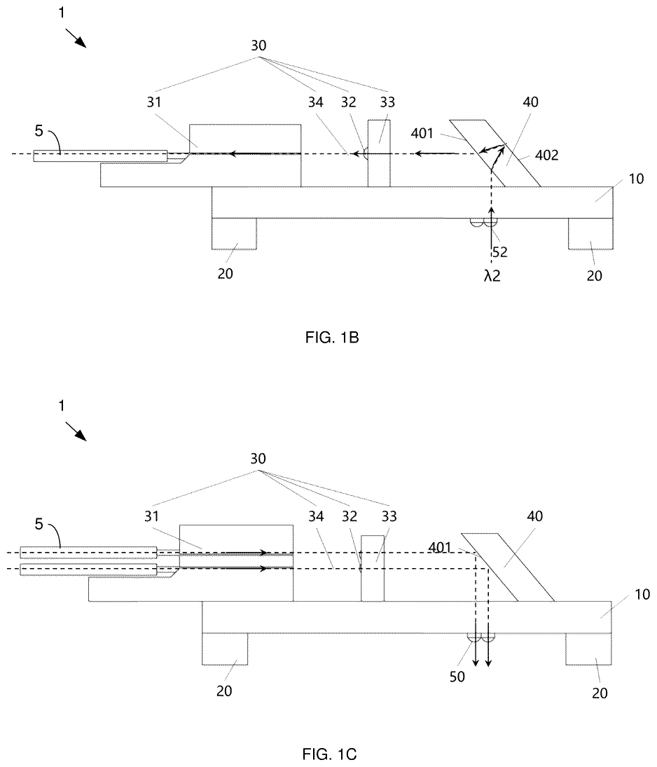

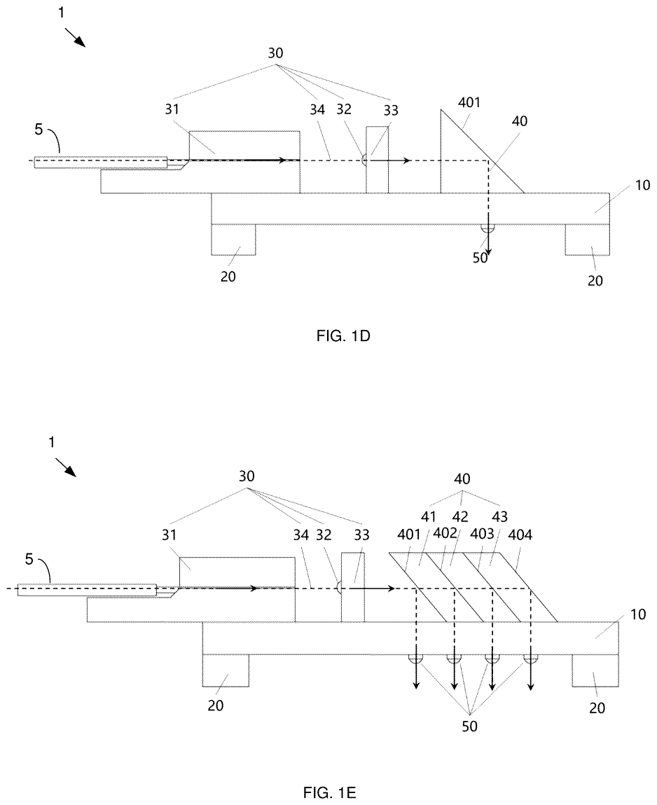

Referring now to FIG. 1, FIG. 1 is an exemplary shortwave module 1 in accordance with the present disclosure. FIG. 1 may comprise a platform 10, glass spacers 20, a light collimation module 30, a light reflection module 40, and a lens array 50. The light collimation module 30 may comprise an optical fiber array 31, a lens array 32, a spacer 33, and an air gap 34. The lens array 50 may comprise a transmitting lens 51 and a receiving lens 52. The optical fiber array 31 may be operable to receive one or more fibers/fiber cores 5.

The light collimation module 30 and the light reflection module 40 may be fixed on the upper side of the platform 10 with optical glue, for example. The spacers 20 and the lens array 50 may be fixed to the lower side of the platform 10. The spacers 20 may be bonded to the platform 10 by glue, for example. The transmitting lens 51 and the receiving lens 52 may be molded directly onto the platform 10 through a polymer on glass (POG) process, a nano imprinting process. The lens array 50 may also be created by molding, embossing, or etching.

The platform 10 may comprise fused silica, for example. The light collimation module 30 may comprise, e.g., a plurality of optical core fibers received by the optical fiber array 31. The fiber cores 5 may be attached to the optical fiber array 31 using MT connectors, for example. The lens array 50 and the spacers 20 may be formed from monocrystalline silicon. The lens array 50 may be one dimensional or two dimensional, in accordance with the requirements of practical applications, namely the number of channels/fibers. The lens array 50 may be made of polymers. The light reflection module 40 may comprise a 45° rhombic prism, for example. The light reflection module 40 may comprise an anti-reflective film coating to the outside face (away from the light collimation module 30) of the rhombic prism of the light reflection module 40. The platform 10 may often be rectangular. The platform 10 may be a trapezoid or of circular shape. The platform 10 may be made of a glass substrate and a lens array 50 may be bonded to it, or imprinted to it.

The spacers 20 may be fixed to the underside of the platform 10, as illustrated in FIG. 1. The dimensions of the spacers 20 may be based on the focal length of the lens array 50 and the position of a signal receiver below platform 10 (not shown). The spacers 20 may be made of glass, silicon, or ceramics.

The optical fiber array 31 may be operable to receive one or more fibers 5. The fibers 5 may be of a specific pitch. Often, the number of fibers is greater than two. The optical fiber array 31 may be operable to couple optical signals into the shortwave module 1. The optical fiber array 31 may be one dimensional or two dimensional. The air gap 34 may be air, or may comprise a combination of air and optical material. The lens array 32 may comprise one or more lenses, typically made from polymers. The lens array 32 may be formed through a POG process, which may not need glue.

The light reflection module 40 may comprise a reflection prism (for example a rhombic prism, as illustrated in FIG. 1), a right-angle prism (as illustrated in FIG. 1D), a diamond-shaped prism, or a prism of another suitable shape. Reflective prisms may be made from glass or other transparent optical materials. The light reflection module 40 may be operable to reflect the horizontally incident light signal arriving from the light collimation module 30 towards the lens array 50 (or vice versa). In some instances, the light reflection module 40 may comprise a plurality of reflection prisms (as illustrated in FIG. 1E). In such cases, the reflective prisms may be bonded together by glue, for example.

Optionally, a light splitting module may be located between the light collimation module 30 and the light reflection module 40 (not shown). A light splitting module may comprise a Z-block, for example, and may be made of glass, silicon, or other transparent optical material. A light splitting module may be operable to demultiplex different wavelength signal lights. Also optionally, a light shrinking module may be located between the light collimation module 30 and the light reflection module 40. A light shrinking module may comprise a plurality of wedge prisms and/or curved lenses. A light shrinking module may be made of glass, silicon, or other transparent optical material. A light shrinking module may be operable to change the diameter of a signal light beam spot. This may be advantageous for signal channel spacing. Further optional is a light deflection module, which may be located between the light collimation module 30 and the light reflection module 40. A light deflection module may comprise an oblique parallelogram prism, and may be made of glass, silicon, or other transparent optical material. A light deflection module may be operable to generate a fixed size spacing in the radial direction by reflecting signal light of different wavelengths.

Using a POG process on the shortwave module 1 may reduce the mounting time of the product, improve the integration and miniaturization, and reduce the cost of the product. Advantages of glass components may be high transmittance and low insertion losses, high thermal stability, low thermal expansion coefficients (compared to plastic polymers used in injection molding, for example), strong scale ability and the applicability of molding, edging, embossing and coating processes. Such an approach may be suitable for low-cost, mass production by employing high precision automatic assembly, for example.

FIG. 1A illustrates an exemplary function of an emission light path, in accordance with the structure illustrated in FIG. 1, in accordance with various embodiments of the disclosure. There is further shown an emission light path of a light signal at wavelength λ1, as a dashed line arrow.

An emission light signal may pass from a fiber 5 through the optical fiber array 31, the air gap 34, the lens array 32, the spacer 33 to the light reflection module 40. The lens array 32 may collimate the emission light signal passing through it. The emission light signal may vertically enter the light reflection module 40 and be redirected to a transmission lens 51. In accordance with various embodiments of the disclosure, there may be one or more emission light paths corresponding to one or more emission light signals.

FIG. 1B illustrates an exemplary function of a reception light path, in accordance with the structure illustrated in FIG. 1, in accordance with various embodiments of the disclosure. There is further shown a reception light path of a light signal at wavelength λ1, as a dashed line arrow.

A reception light signal may be received at a receiving lens 52, for example from a laser. The reception light signal may be at a wavelength of λ2. The reception light signal may be collimated by receiving lens 52 and be reflected at surface 402 of the light reflection module 40, towards spacer 33. The reception light signal may be refracted at surface 401. The reception light signal may then traverse spacer 33, lens array 32, air gap 34 and be coupled to fiber 5 in the optical fiber array 31. In accordance with various embodiments of the disclosure, a spacer 33 and air gap 34 may not be present in the reception light path. In accordance with various embodiments of the disclosure, there may be one or more reception light paths corresponding to one or more reception light signals.

FIG. 1C illustrates an exemplary function of a plurality of emission paths, in accordance with various embodiments of the disclosure. There is further shown two emission light paths, as dashed line arrows.

In FIG. 1C, there is shown a cross-section of an embodiment of the disclosure comprising a two-dimensional fiber array 31. The optical fiber array 31 may be operable to receive 24 fibers in a 12 rows by 2 columns arrangement, for example. Correspondingly, the lens array 32 may also comprise an equal number of lenses, i.e., 24 in this example. The lens array 32 and the spacer 33 may be made of monocrystalline silicon, for example. The plurality of emission light paths/signals may be reflected and redirected to the lens array 50 at surface 401 of the light reflection module 40. There may be an eflective film coating on the surface 401.

FIG. 1D illustrates an exemplary embodiment of the shortwave module according to various embodiments of the disclosure. There is shown a light reflection module 40 comprising a 45° right angle prism. Illustrated, as a dashed line arrow, is an emission light signal. In accordance with various embodiments of the invention, the emission light signal is reflected and redirected towards a lens 50 on the surface 401 of the light reflection module 40. In accordance with various embodiments of the disclosure, there may be one or more emission light paths corresponding to one or more emission light signals that may be redirected towards a lens array 50.

FIG. 1E illustrates an exemplary embodiment of the short-wave module according to various embodiments of the disclosure comprising a plurality of rhombic prisms. There is shown a light reflection module 40 comprising a plurality of rhombic prisms 41, 42, 43. In accordance with various embodiments of the disclosure, the surfaces 401, 402, 403, and 404, may be coated with film that is reflective for different wavelengths. In this figure, the dashed line arrow may represent a mixed wavelength signal. The mixed wavelength signal may be reflected and redirected on one of the surfaces 401, 402, 403, and 404, depending on the wavelength at which the surfaces are reflective. In this manner, each of the reflective surfaces may reflect and redirect only a specific range of wavelengths towards one or more lenses of the lens array 50. Accordingly, such as setup may be advantageous to separate signals of different optical wavelengths into separate channels.

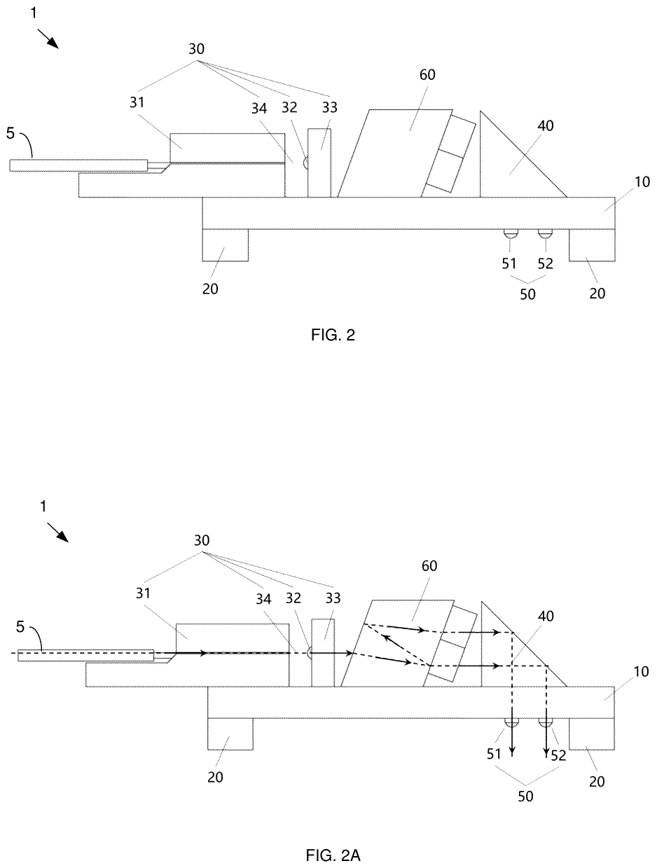

FIG. 2 illustrates an exemplary embodiment of the short-wave module according to various embodiments of the disclosure comprising a splitting prism. There is further shown a splitting prism 60. The splitting prism 60 may be made of optical glass.

FIG. 2A illustrates the function of the embodiment shown in FIG. 2. There is shown a transmission light signal comprising a plurality of wavelengths, as dashed line arrows. The light signal may be sent from the optical fiber array 31 through an air gap 34, a lens 32, and a spacer 33 into the splitting prism 60. In the light splitting prism 60, the light signal may be reflected twice and may be divided into a first signal portion corresponding to a first wavelength and a second signal portion corresponding to a second wavelength. The first signal portion and the second signal portion may exit splitting prism 60 in different physical locations, as illustrated. Because of this different physical exit location from the splitting prism 60, the first signal portion and the second signal portion are also reflected in different physical locations in the light reflecting module 40 (shown is an exemplary 45° right angle prism), and may therefore be directed into different lenses 51, 52 of the lens array 50. This setup may be advantageous for separating different wavelength signals into different channels, similar to the embodiment shown in FIG. 1E.

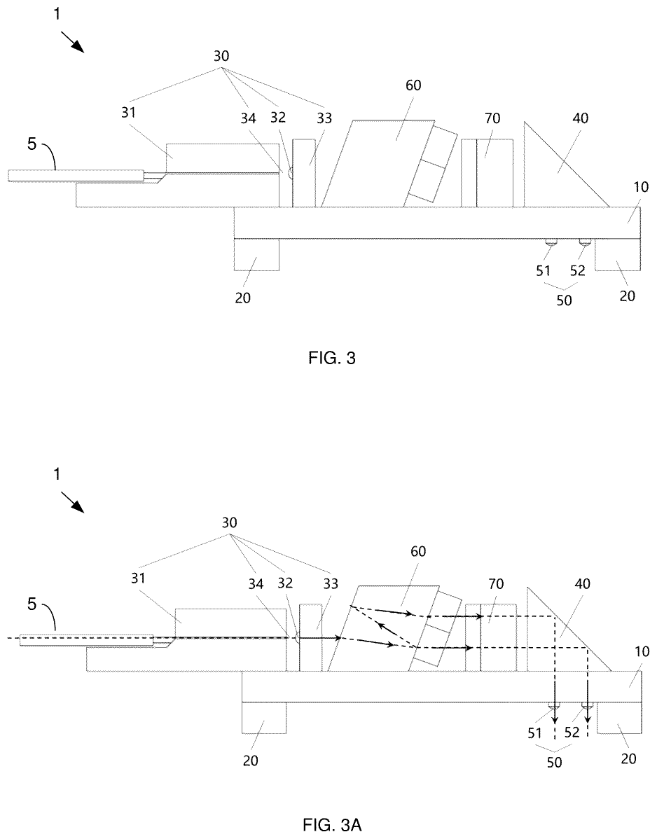

FIG. 3 illustrates an exemplary embodiment according to the disclosure further comprising a light shrinking module 70. The light shrinking module 70 may be arranged to reduce the diameter of an incident light beam at its output.

FIG. 3A illustrates the function of the shortwave module according to the embodiment of FIG. 3. In the splitting prism 60, a multi-wavelength incident light signal may be separated into a plurality of beams according to wavelengths. An exemplary splitting prism 60 showing two exiting light beams of different wavelengths are illustrated. The beam diameters of these two light beams incident on light shrinking module 70 may be reduced in the light shrinking module 70, so that the illustrated light beams exiting light shrinking module 70 may have a smaller beam diameter. The light shrinking module 70 may be used to improve the physical separation between light beams, for example.

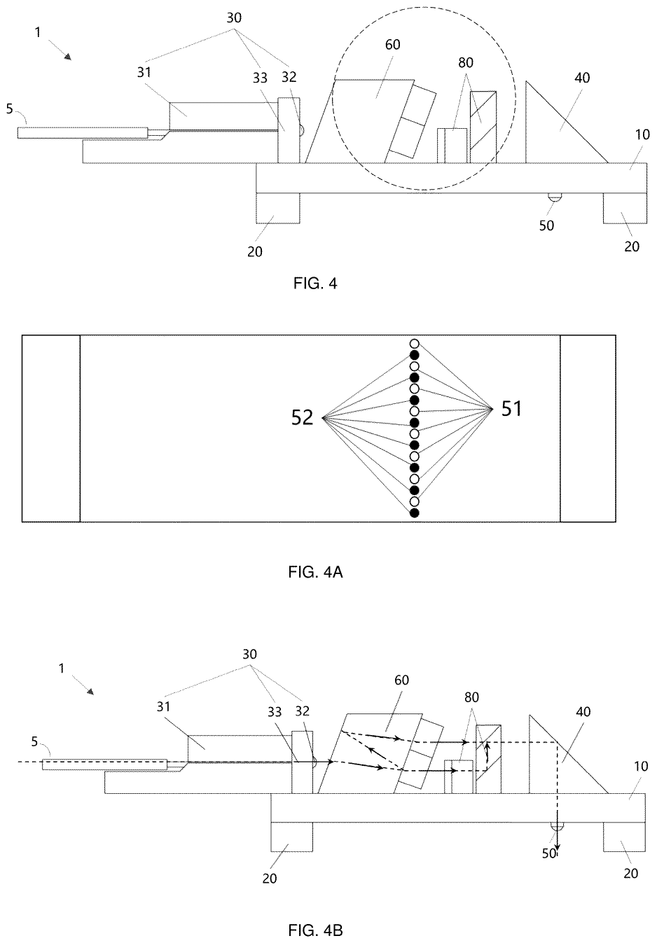

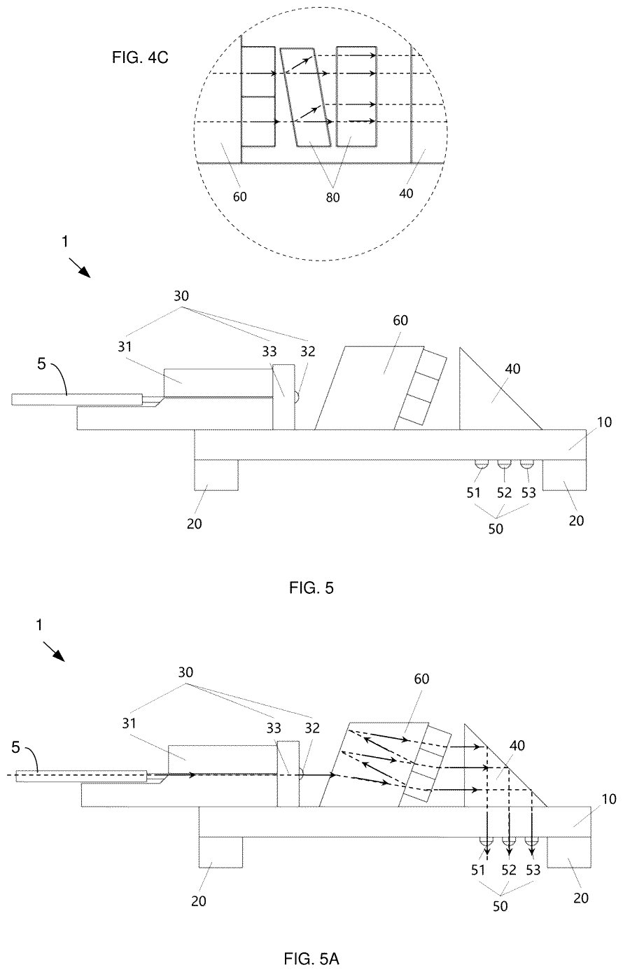

FIG. 4 illustrates an exemplary embodiment according to the disclosure, further comprising a light deflection prism 80.

FIG. 4A illustrates a partial top view of the embodiment shown in FIG. 4. There is shown a lens array 50 comprising groups of mutually staggered lens arrays 51 and 52. There may be a fixed pitch between the lens array 51 and the lens array 52. For example, the fixed pitch may be 250 μm. The lens array 51 and the lens array 52 may be used, for example, to receive optical signals of different wavelengths. The optical signals of different wavelengths may be optically coupled to the lens array 52 and 51 from the splitting prism 60. The lens arrays 51 and 52 may be made of organic polymers and/or may be batch molded onto platform 10 through a POG process, for example.

FIG. 4B illustrates the function of the exemplary embodiment shown in FIG. 4. For example, at least two light beams of different wavelengths may exit the light splitting prism 60. These at least two light beams may be incident on the light deflection prism 80. The light deflection prism 80 may be operable to align the two beams at the output of the light deflection prism 80 in the vertical dimension, as illustrated in that both beams exit the light deflection prism 80 at the same vertical level. However, the two light beams may be separated in the horizontal dimension. For example, one of the two light beams may be incident on the lens array 52, while the other light beam may be incident on the lens array 51, as illustrated by the staggered lens arrays 51 and 52 in FIG. 4A.

FIG. 4C is a partial top view of FIG. 4, illustrating the lateral deflection effect of the deflection prism 80 on the light.

FIG. 5 illustrates an exemplary shortwave optical module, in accordance with various embodiments of the disclosure. FIG. 5A illustrates the function of the exemplary embodiment of FIG. 5. FIG. 5 and FIG. 5A may be similar to FIG. 2 and FIG. 2A, respectively. The difference is that FIG. 5 and FIG. 5A illustrates a light splitting prism 60 operable to split the incident light into 3 different output beams according to 3 different wavelengths, versus two illustrated wavelengths in FIG. 2 and FIG. 2A. Correspondingly, the lens array 50 may comprise at least three lenses/lens arrays 51, 52, 53.

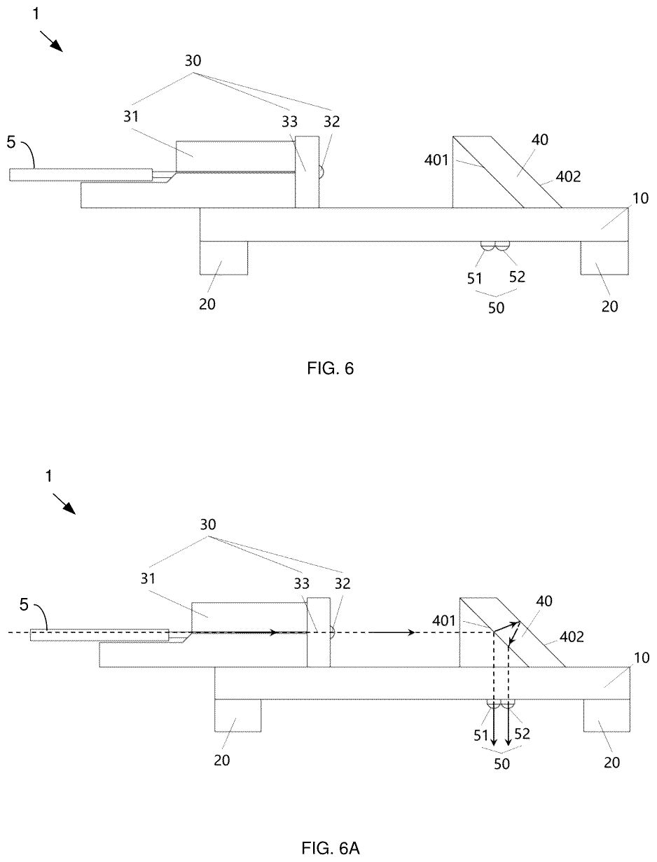

FIG. 6 illustrates a shortwave optical module in accordance with various embodiments of the disclosure, further comprising a trapezoidal light reflection module 40. FIG. 6A illustrates the operation of an embodiment of the disclosure according to FIG. 6. There is shown a dashed line arrow to illustrate an emission light path and signal. The light reflection module is arranged to comprise (partly) reflective surfaces 401 and 402. A first portion of the light incident on the light module 40 may be reflected and redirected at surface 401, towards lens 51. A second portion of the light incident on the light module 40 may be reflected and redirected at surface 402, towards lens 52. Such a setup may be advantageous for dividing an incident light beam to light reflection module 40 into two channels. For example, the light reflection module 40 may act as a beam splitter that may split a beam into two channels, each channel comprising a certain power of the incident light signal.

The present disclosure comprises reference to certain examples; however, it will be understood by those skilled in the art that various changes may be made and equivalents may be substituted without departing from the scope of the disclosure. In addition, modifications may be made to the disclosed examples without departing from the scope of the present disclosure. Therefore, it is intended that the present disclosure not be limited to the examples disclosed, but that the disclosure will comprise all examples falling within the scope of the appended claims.

What is claimed is:

1. A shortwave optical module, said module comprising:
a glass platform;
one or more glass spacers;
a light collimation module;
a glass light reflection module; and
one or more glass lens arrays.

2. The module of claim 1, wherein said glass comprises monocrystalline silicon, fused silica, fused quartz, polymer glass, or a glass-like transparent material with a refractive index similar to glass.

3. The module of claim 1, wherein said one or more glass spacers are made of the same material as at least one of said one or more lens arrays.

4. The module of claim 1, wherein said light collimating module comprises an optical fiber array, a lens array, a spacer, and an optional air gap.

5. The module of claim 1, wherein said light collimation module may comprise a light splitting module, a light shrinking module, or a light deflection module.

6. The module of claim 5, wherein said light splitting module comprises a Z-block.

7. The module of claim 5, wherein said light shrinking module comprises a plurality of wedge modules and/or curved lenses.

8. The module of claim 5, wherein said light deflection module comprises an oblique parallelogram prism.

9. The module of claim 5, wherein said one or more glass lens arrays comprise a plurality of lenses.

10. The module of claim 1, wherein said one or more glass lens arrays are made using high-precision cold processing, a polymer on glass imprinting process, a molding process, an embossing process, or an etching process.

11. The module of claim 1, wherein said glass light reflection module comprises one or more rhombic prisms, a right-angle prism, a diamond-shaped prism, or a trapezoidal prism.

12. The module of claim 1, wherein said glass light reflection module comprises one or more anti-reflective coatings.

13. The module of claim 1, wherein said shortwave optical module comprises a splitting prism, operable to physically separate an incident light into a plurality of signals of different wavelengths.

14. The module of claim 1, wherein said shortwave optical module comprises a light deflection module operable to vertically align a plurality of light beams at the output of said light deflection module.

15. The module of claim 1, wherein said shortwave optical module comprises a trapezoidal prism operable as beam splitter for an incident light beam.

16. A method of fabricating a shortwave optical module, said method comprising:
providing a glass platform;
coupling one or more glass spacers to said glass platform;
coupling a light collimation module to said glass platform;
coupling a glass light reflection module to said glass platform; and
generating on said glass platform one or more glass lens arrays, or coupling to said glass platform one or more glass lens arrays.

17. The method of claim 16, comprising using monocrystalline silicon, fused silica, fused quartz, polymer glass, or a glass-like transparent material with a refractive index similar to glass for said glass.

18. The method of claim 16, comprising making said one or more glass spacers from the same material as at least one of said one or more lens arrays.

19. The method of claim 16, comprising forming said light collimating module from an optical fiber array, a lens array, a spacer, and an optional air gap.

20. The method of claim 16, comprising forming said light collimation module from a light splitting module, a light shrinking module, and/or a light deflection module.

21. The method of claim 20, comprising employing a Z-block in said light splitting module.

22. The method of claim 20, comprising employing a plurality of wedge modules and/or curved lenses in said light shrinking module.

23. The method of claim 20, comprising employing an oblique parallelogram prism in said light deflection module.

24. The method of claim 20, comprising employing a plurality of lenses in said one or more glass lens arrays.

25. The method of claim 16, comprising generating said one or more glass lens arrays by high-precision cold processing, a polymer on glass imprinting process, a molding process, an embossing process, or an etching process.

26. The method of claim 16, comprising employing one or more rhombic prisms, a right-angle prism, a diamond-shaped prism, or a trapezoidal prism in said glass light reflection module.

27. The method of claim 16, comprising employing one or more anti-reflective coatings in said glass light reflection module.

28. The method of claim 16, comprising employing a splitting prism operable to physically separate an incident light into a plurality of signals of different wavelengths in said shortwave optical module.

29. The method of claim 16, comprising employing a light deflection module operable to vertically align a plurality of light beams at the output of said light deflection module in said shortwave optical module.

30. The method of claim 16, comprising employing a trapezoidal prism operable as beam splitter for an incident light beam in said shortwave optical module.
